(19) United States
(12) Patent Application Publication
(10) Pub. No.: US 2015/0355690 A1
(43) Pub. Date: Dec. 10, 2015

(54) COMMUNICATION APPARATUS

(71) Applicant: ALAXALA Networks Corporation, Kawasaki-shi, Kanagawa (JP)

(72) Inventor: Junji BABA, Kawasaki-shi (JP)

(73) Assignee: ALAXALA NETWORKS CORPORATION, Kawasaki-shi, Kanagawa (JP)

(21) Appl. No.: 14/760,504

(22) PCT Filed: Sep. 3, 2013
(86) PCT No.: PCT/JP2013/073692

§ 371 Date: Jul. 13, 2015

(30) Foreign Application Priority Data
Mar. 14, 2013 (JP) 2013-052277

(51) Int. Cl. G06F 1/20; G06F 13/40; G06F 13/42

(52) U.S. Cl. CPC G06F 1/20; G06F 13/426; G06F 13/409; G06F 13/4022

(57) ABSTRACT

It is provided a communication apparatus, including: a plurality of circuit boards; a casing configured such that air is controlled to flow in a ventilation direction: a coupling plate being arranged between a first surface and a second surface in the casing, and having ventilation holes for communicating a first space on the first surface side and a second space on the second surface side to each other, the coupling plate having the plurality of circuit boards coupled to a third surface which faces the first surface; and cables routed in a third space defined in the second space excluding fourth spaces in which the ventilation holes are projected on the second surface in the ventilation direction, the cables coupling the plurality of circuit boards to each other on a fourth surface which faces the second surface so that the plurality of circuit boards are communicable to each other.

### CLAIM OF PRIORITY

The present application claims priority from Japanese patent application JP 2013-052277 filed on Mar. 14, 2013, the content of which is hereby incorporated by reference into this application.

### BACKGROUND OF THE INVENTION

This invention relates to a communication apparatus for transmitting and receiving data.

In recent years, along with growing use of smartphones, tablets, and the like, the volume of Internet traffic has continued to increase. Under the circumstances, demands for higher processing speed and wider bandwidths have been increasingly imposed on network communication apparatus. In order to meet such demands, attempts have been made to transmit signals at higher speed between circuit board units for executing various kinds of processing in the network communication apparatus.

JP 2011-146470 A discloses an electronic apparatus configured to transmit the signals at higher speed between the circuit board units. The electronic apparatus of JP 2011-146470 A includes a plurality of circuit board units removable from the electronic apparatus, a relay circuit board for electrically coupling the circuit board units arranged in the electronic apparatus to each other, and at least one of electrical cables for electrically coupling the circuit board units arranged in the electronic apparatus to each other or optical fiber cables for optically coupling the circuit board units to each other. In the electronic apparatus of JP 2011-146470 A, high-speed signals are transmitted through the cables so that the speed of transmitting the signals between the circuit board units becomes higher.

In a communication apparatus having a backplane structure, such as the electronic apparatus of JP 2011-146470 A, the relay circuit board is arranged as a backplane on a depth of the circuit board units to be inserted from a front surface side toward a rear surface side of the apparatus. Ventilation holes for allowing cooling air to flow therethrough are not formed through the backplane, and hence the electronic apparatus of JP 2011-146470 A employs a right-and-left air intake/exhaust system.

In recent years, in order to conform to the network equipment building system (NEBS), which is a standard for communication apparatus for telecommunications carriers, there have been increasing demands for employment of a cooling system of a front-and-rear air intake/exhaust type as a cooling system for communication apparatus. However, the electronic apparatus of JP 2011-146470 A does not conform to the NEBS.

When the ventilation holes for allowing cooling air to flow therethrough are formed through the backplane so that the cooling system of the front-and-rear air intake/exhaust type is arranged in the electronic apparatus as disclosed in JP 2011-146470 A, the cables for electrically or optically coupling the circuit board units to each other are arranged on a rear surface of the backplane. Thus, there is a problem in that the cables close the ventilation holes to hinder the flow of the cooling air.

Further, the cables are rocked due to impingement of the cooling air, and hence contact between the cables and connectors may be disturbed. Specifically, as for the electrical coupling cables, there is a risk of malfunctions due to contact failures or increase in electrical resistance. The optical coupling cables are more liable to be influenced by increase in loss due to optical axis misalignment or coupling angle fluctuation. When the optical cables are bent more than necessary so as not to hinder the flow of the cooling air, there are problems in that the optical cables are damaged or deteriorated characteristics.

### SUMMARY OF THE INVENTION

It is an object of this invention to provide an apparatus including cables arranged so that signals to be transmitted through the cables are not influenced.

An aspect of the invention disclosed in this application is a communication apparatus, including: a plurality of circuit boards; a casing to which the plurality of circuits boards are inserted, the casing being configured such that air is controlled to flow in a ventilation direction as one of: a direction in which air taken in through a first surface of the casing is controlled to flow between the plurality of circuits boards and exhausted to an outside of the communication apparatus through a second surface of the casing opposite to the first surface, and in which the plurality of circuits boards are one of inserted and removed; and a direction in which air taken in through the second surface is controlled to flow between the plurality of circuit boards and exhausted to the outside through the first surface, and in which the plurality of circuits boards are one of inserted and removed; a coupling plate being arranged between the first surface and the second surface in the casing, and having ventilation holes for communicating a first space on the first surface side and a second space on the second surface side to each other, the coupling plate having the plurality of circuit boards coupled to a third surface of the coupling plate, which faces the first surface; and cables routed in a third space defined in the second space excluding fourth spaces in which the ventilation holes are projected on the second surface in the ventilation direction, the cables coupling the plurality of circuit boards to each other on a fourth surface which faces the second surface so that the plurality of circuit boards are communicable to each other.

According to a representative embodiment of this invention, the communication apparatus including cables arranged so that signals to be transmitted through the cables are not influenced can be provided. Other objects, configurations, and effects than those described above are clarified by the following description of an embodiment.

### BRIEF DESCRIPTION OF THE DRAWINGS

FIG. 1 is a block diagram for illustrating an example of a plurality of circuit boards and a coupling relationship therebetween.

FIG. 2 is a block diagram for illustrating another example of the plurality of circuit boards and the coupling relationship therebetween.

FIG. 3 is an exploded perspective view for illustrating a communication apparatus according to a first embodiment of this invention.

FIG. 4 is a front and side sectional view for illustrating the communication apparatus according to the first embodiment.

FIG. 5 is a front view for illustrating the backplane according to the first embodiment.

FIG. 6 is a rear view for illustrating the backplane according to the first embodiment.

FIG. 7 is a side view for illustrating the fixing member and the cable 400 fixed by the fixing member.

FIG. 8 is an exploded perspective view for illustrating the communication apparatus in which still another example of the rocking suppressing means for the cables is employed.

FIG. 9 is an explanatory view for illustrating a coupling relationship between the circuit boards according to the first modification in a three-dimensional manner.

FIG. 10 is a rear view for illustrating the backplane according to the first modification.

FIG. 11 is an exploded perspective view for illustrating the communication apparatus according to the second modification.

FIG. 12 is a front view for illustrating the backplane according to the second modification.

FIG. 13 is a rear view for illustrating the backplane according to the second modification.

FIG. 14 is an explanatory view for illustrating a coupling relationship between the circuit boards according to the third modification in a three-dimensional manner.

FIG. 15 is a rear view for illustrating the backplane according to the third modification.

FIG. 16 is an exploded perspective view for illustrating the communication apparatus according to the fourth modification.

FIG. 17 is a rear view for illustrating the backplane according to the fourth modification.

FIG. 18 is a rear view for illustrating the backplane according to the fifth modification.

### DETAILED DESCRIPTION OF THE PREFERRED EMBODIMENTS

A cooling system for communication apparatus according to this invention is a cooling system of a front-and-rear air intake/exhaust type in which ventilation holes for allowing cooling air to flow therethrough are formed through a backplane. First, prior to description of the cooling system for the communication apparatus, description is made of circuit boards to be arranged in the communication apparatus.

<Plurality of Circuit Boards and Coupling Relationship Therebetween>

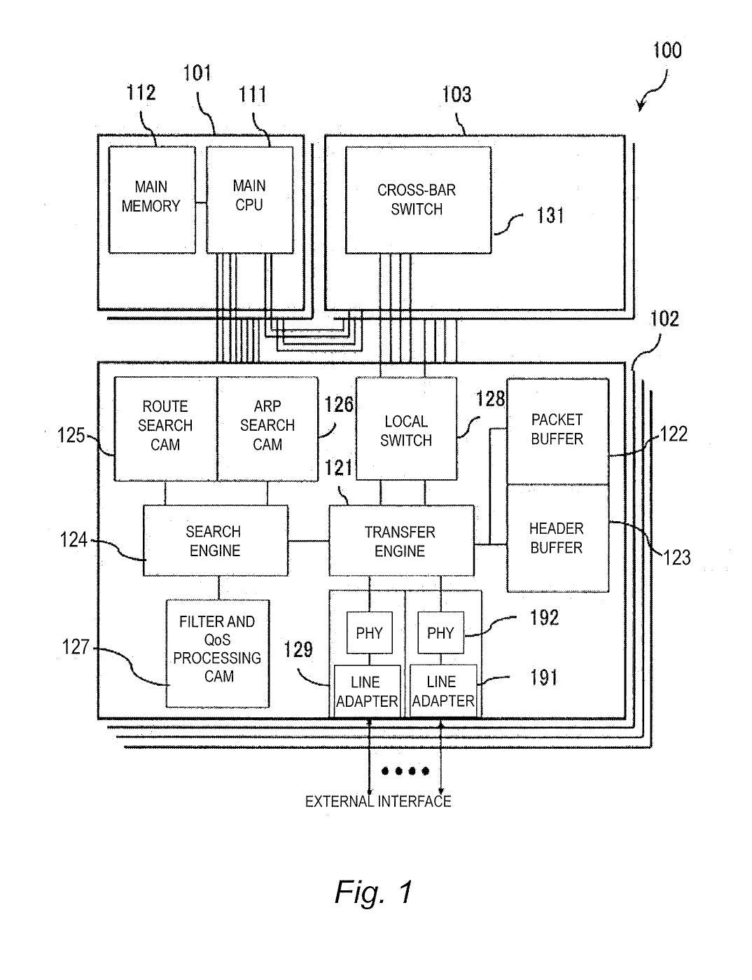

FIG. 1 is a block diagram for illustrating an example of a plurality of circuit boards and a coupling relationship therebetween. A plurality of circuit boards 100 include a plurality of basic control units 101, a plurality of packet processing units 102, and a plurality of switch fabric units 103.

The basic control units 101 each include a main central processing unit (CPU) 111 and a main memory 112. The basic control units 101 each perform apparatus management, routing information management, protocol processing, and interface control. The basic control units 101 input and output control signals for the above-mentioned control to the plurality of packet processing units 102, the plurality of switch fabric units 103, and power supply units described below.

The packet processing units 102 each analyze and transfer packets. The packet processing units 102 each include a transfer engine 121, a packet buffer 122, a header buffer 123, a search engine 124, a route search content address memory (CAM) 125, an address resolution protocol (ARP) search CAM 126, a filter and quality of service (QoS) processing CAM 127, a local switch 128, and a network interface (NIF) unit 129.

The switch fabric units 103 each include a cross-bar switch 131. Through intermediation of a backplane, the cross-bar switches 131 are mutually coupled to the local switches 128 mounted to the packet processing units 102. With this, backplane transmission is performed between the packet processing units 102 coupled to each other through intermediation of the cross-bar switches 131.

The NIF unit 129 is mounted to each of the packet processing units 102. The NIF unit 129 is an input/output port to be coupled to networks such as a wide area network (WAN) and a local area network (LAN). Specifically, the NIF unit 129 includes line adapters 191 and physical layer (PHY) chips 192. The PHY chips 192 execute physical layer processing such as establishment, maintenance, or release of physical coupling.

The basic control units 101, the packet processing units 102, and the switch fabric units 103 are generally arranged as circuit boards, and mutually coupled through intermediation of the backplane. The NIF unit 129 may be arranged as a single element in the packet processing unit 102, or as an independent circuit board. In this example, the former configuration is employed. Further, the transfer engine 121, the search engine 124, the local switch 128, the cross-bar switch 131, and other components are each arranged as large scale integration (LSI) in which necessary functions are integrated.

Next, brief description is made of a flow of packet processing in the communication apparatus. After packets from an external interface arrive at the NIF unit 129, the packets are transmitted to the transfer engine 121 via the line adapters 191 and the PHY chips 192. The transfer engine 121 controls data information and header information, which are contained in the packets, to be stored respectively in the packet buffer 122 and the header buffer 123. For example, a header of an Ethernet packet (Ethernet is a trademark: the same applies hereinafter) contains information items such as a synchronization preamble, a start frame, a source media access control (MAC) address, and a destination MAC address, and a data length.

The search engine 124 receives the header information from the transfer engine 121, and refers to tables to acquire information items necessary for control of packet transfer. Examples of the tables to be referred to by the search engine 124 include a routing table, an ARP table, and a filter and QoS table. In this embodiment, the search engine 124 refers to the routing table and the filter and QoS table. The routing table is a table for executing route search processing, which is stored in the route search CAM 125. The filter and QoS table contains information items such as a packet filtering condition, a packet discard condition, and a priority of the packet transfer processing in the communication apparatus. The filter and QoS table is stored in the filter and QoS processing CAM 127. Results of searches of those tables are returned to the transfer engine 121.

Based on the search results, the transfer engine 121 specifies the input/output port through which the packets are to be transferred, and transfers the packets sequentially to the local switch 128 and the cross-bar switch 131 mounted to the switch fabric unit 103. Further, the cross-bar switch 131 transfers the packets to another corresponding packet processing unit 102, in which the packets are transferred from the local switch 128 to the transfer engine 121. The transfer engine 121 controls the received packets to be stored in the packet buffer 122 and the header buffer 123. The search engine 124 receives header information from the transfer engine 121, and acquires a MAC address from an ARP table stored in the ARP search CAM 126.

The ARP table is a table for showing correspondence between internet protocol (IP) addresses and MAC addresses that are used for Ethernet communication. The ARP table stores information of port numbers corresponding to the MAC addresses of apparatus to be coupled. Results of search of this table are returned to the transfer engine 121, and the packets are transmitted to the external interface via the NIF unit 129 having the specified input/output poi L. In this way, in the communication apparatus, data is transferred between the plurality of circuit boards 100.

In recent years, a serializer/deserializer (SerDes) for serializing data to be transmitted via a bus has been employed so that data is transmitted at high speed between the circuit boards 100. In many cases, the SerDes is used to perform high-speed data transmission via the backplane in the communication apparatus. However, loss at high frequencies and intersymbol interference may occur in the transmission line. As a result, there is a problem in that data cannot be correctly received on a reception side. As technologies for solving such problems due to the loss at high frequencies and the intersymbol interference, equalization technologies have been widely used. There are the following two examples of the equalization technologies.

De-emphasis (Equalization technology performed on data transmission side)

Equalizing (Equalization technology performed on data reception side)

The de-emphasis is an equalization technology of emphasizing an output voltage level of an output buffer on the data transmission side in accordance with frequency response of a transmission loss in the transmission line so that an amplitude of a signal to be received by an input buffer is equalized. The equalizing is an equalization technology of increasing gain characteristics of the input buffer only in a specific frequency band on the data reception side in accordance with the frequency response of the transmission loss in the transmission line so that the amplitude of the signal to be received by the input buffer is equalized. In the communication apparatus, training processing is executed at the time of start-up of the apparatus so that an emphasis value of a de-emphasis circuit in the output buffer is optimized, and that gain characteristics of an amplifier circuit in the input buffer are optimized in a specific frequency band. Then, operation of the apparatus is started. With this, communication quality is secured.

It should be noted that the backplane for mutually coupling the circuit boards 100 generally includes a circuit board or electrical cables, but performance of electrical transmission is reaching a limit in view of the loss at high frequencies. Under the circumstances, optical cables are also employed.

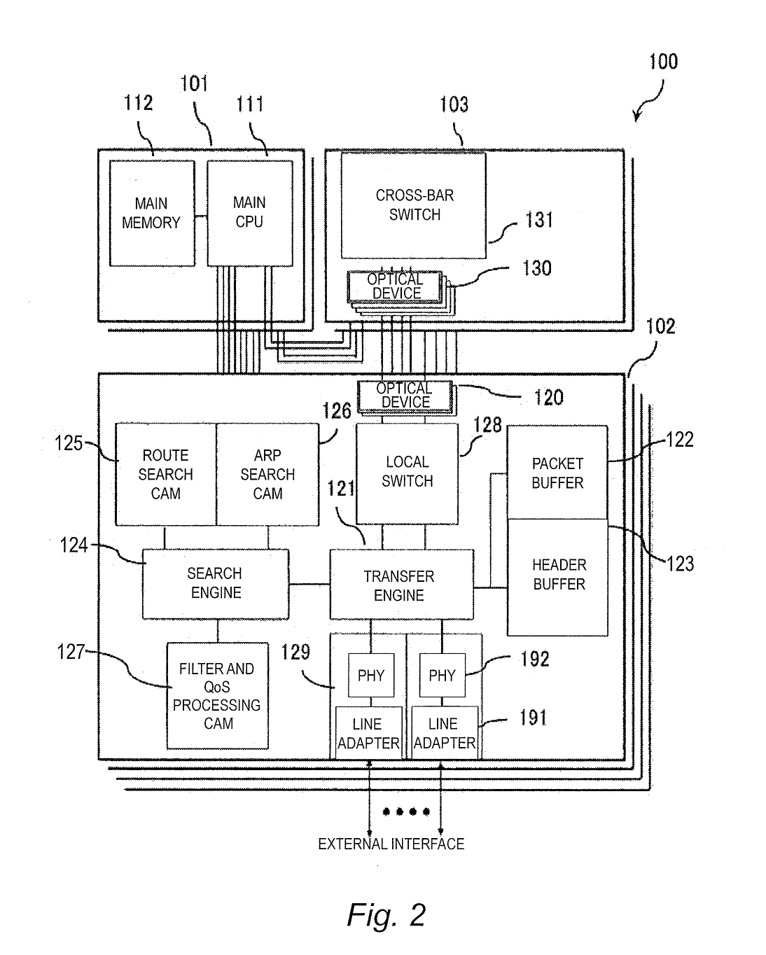

FIG. 2 is a block diagram for illustrating another example of the plurality of circuit boards 100 and the coupling relationship therebetween. In FIG. 2, an optical device 120 to be coupled to the local switch 128 is mounted to each of the packet processing units 102. Further, an optical device 130 to be coupled to the cross-bar switch 131 is mounted to each of the switch fabric units 103. With this, the optical device 120 of the packet processing unit 102 and the optical device 130 of the switch fabric unit 103 are coupled to each other, thereby enabling optical transmission.

Next, description is made of the cooling system for the communication apparatus to which the above-mentioned circuit boards 100 are mounted. As described above, the cooling system for the communication apparatus according to this invention is the cooling system of the front-and-rear air intake/exhaust type in which the ventilation holes for allowing cooling air to flow therethrough are formed through the backplane. It should be noted that, in the following embodiment, description is made by way of an example of the coupling relationship between the circuit boards 100 of FIG. 2.

### First Embodiment

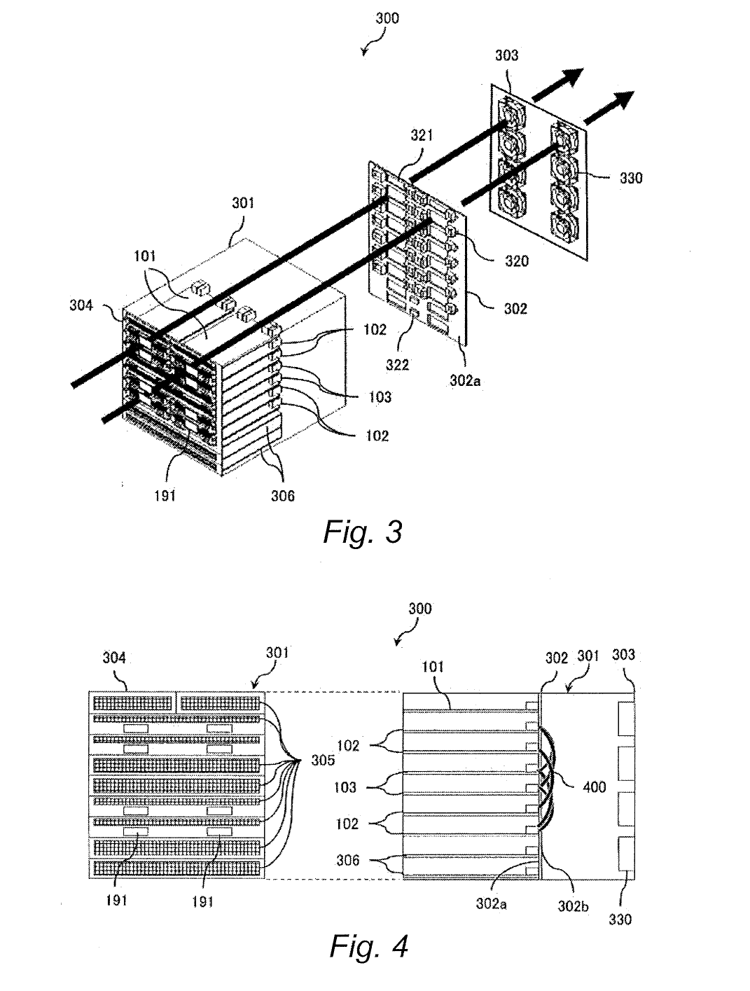

FIG. 3 is an exploded perspective view for illustrating a communication apparatus according to a first embodiment of this invention, and FIG. 4 is a front and side sectional view for illustrating the communication apparatus according to the first embodiment. A communication apparatus 300 includes a casing 301, a backplane 302, and a rear plate 303. Further, the thick arrows in FIG. 3 indicate a flow direction of the cooling air. In the casing 301, the plurality of circuit boards 100 illustrated in FIG. 1 are arranged. The plurality of circuit boards 100 are inserted in a horizontal state from the front of the casing 301. As an example of the plurality of circuit boards 100 in the casing 301, the basic control units 101 are inserted into a first row from the top, the packet processing units 102 are inserted into a second row, a third row, a sixth row, and a seventh row, and the switch fabric units 103 are inserted into a fourth row and a fifth row. It should be noted that power supply units 306 are inserted into an eighth row and a ninth row (lowermost row). The power supply unit 306 is also a type of the circuit boards 100.

A front plate 304 is arranged in the front of the casing 301. The front plate 304 has mesh-like ventilation holes 305 for allowing cooling air to flow therethrough into the casing 301. With this, the cooling air is taken into the casing 301 through the front plate 304. Further, the line adapters 191 of the circuit boards 100 are exposed on the front plate 304. With this, the cooling air is allowed to flow, and at the same time, the external interface and the line adapters 191 can be coupled to each other.

The backplane 302 is a board (coupling plate) for coupling the plurality of circuit boards 100 to each other. A plurality of connectors 320 are arranged on a front surface 302a as a surface on one side of the backplane 302, and the connectors 320 are coupled to the circuit boards 100. Further, a plurality of ventilation holes 321 are formed through the backplane 302. The circuit boards 100 coupled to the backplane 302 are arranged to partially close the corresponding ventilation holes 321. In order to allow the flow of the cooling air, the circuit boards 100 do not fully close the corresponding ventilation holes 321.

With this, the cooling air, which has flowed between the circuit boards 100, flows through the ventilation holes 321. Further, cables 400 for electrically or optically coupling the circuit boards 100 to each other are routed on a rear surface 302b side on another side of the backplane 302 through intermediation of the connectors 320. With this, signals can be transmitted between the circuit boards 100, and power is supplied thereto. It should be noted that the number of the circuit boards 100 to be mounted is not limited to that in FIG. 3 and FIG. 4.

Further, as described above, in order to enhance reliability of the communication apparatus 300, the plurality of power supply units 306 are inserted into the casing 301. With this, the communication apparatus 300 is made redundant. The plurality of power supply units 306 are inserted in a horizontal state from the front of the communication apparatus 300. As power sources for the communication apparatus 300, an AC power source of AC 100 [V] or AC 200 [V], or a DC power source of DC 48 [V] is used in many cases, and those voltages are applied to the power supply units 306. The power supply units 306 output a voltage of DC 48 [V] or DC 12 [V] through AC/DC conversion or DC/DC conversion.

The power supply units 306 are coupled to the backplane 302 by power supply unit connectors 322 as an example of the connectors 320 so that the voltage of DC 48 [V] or DC 12 [V] is supplied to the circuit boards 100 via the backplane 302. It should be noted that the number of the power supply units 306 to be mounted is not limited to that in FIG. 3 and FIG. 4.

A plurality of cooling fans 330 are mounted to the rear plate 303. The cooling fans 330 are arranged along the direction of stacking the circuit boards 100. The cooling fans 330 control the communication apparatus 300 to forcibly take in the cooling air through the front plate 304 of the communication apparatus 300, and to exhaust the cooling air that has flowed between the circuit boards 100 and through the ventilation holes 321. The number of the cooling fans 330 to be mounted is not limited to that in FIG. 3 and FIG. 4.

In this way, the backplane 302 partitions a space in the casing 301 into a first space on the front surface 302a side to which the plurality of circuit boards 100 are coupled, and a second space on the rear surface 302b side on which the cables 400 are routed. The first space and the second space are communicated to each other through the ventilation holes 321. Further, in the second space, the cables 400 are routed in a third space excluding fourth spaces in which the ventilation holes 321 are projected on the rear surface 302b in a ventilation direction of the cooling air.

With this, the cooling air through the front of the casing 301 is less liable to impinge on the cables 400, and hence the flow of the cooling air is not hindered. Further, when the cooling air is less liable to impinge on the cables 400, the cables 400 are suppressed from being rocked. Thus, when electrical cables are used as the cables 400, contact failures and increase in electrical resistance are suppressed. As a result, malfunctions can be suppressed. Further, when optical cables are used as the cables 400, loss due to optical axis misalignment or coupling angle fluctuation can be reduced.

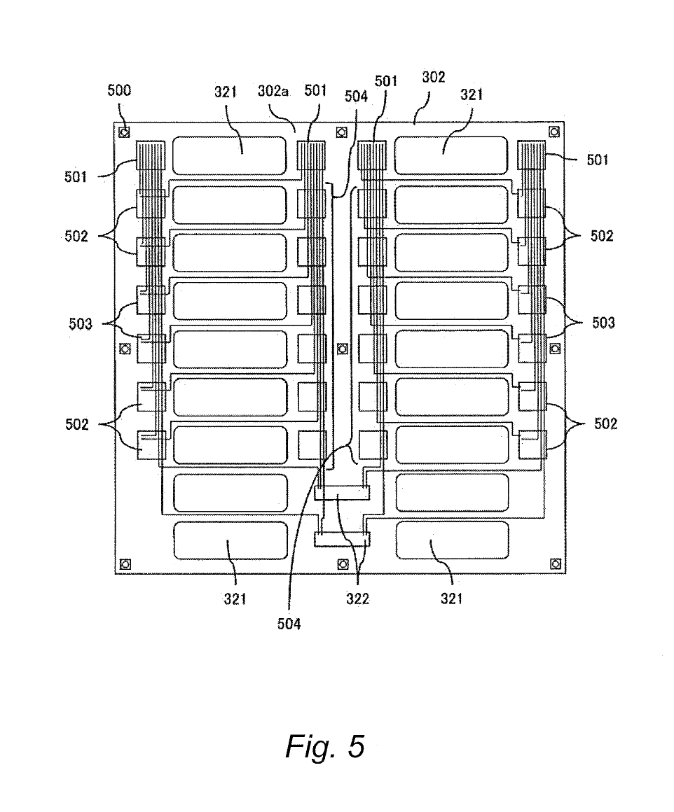

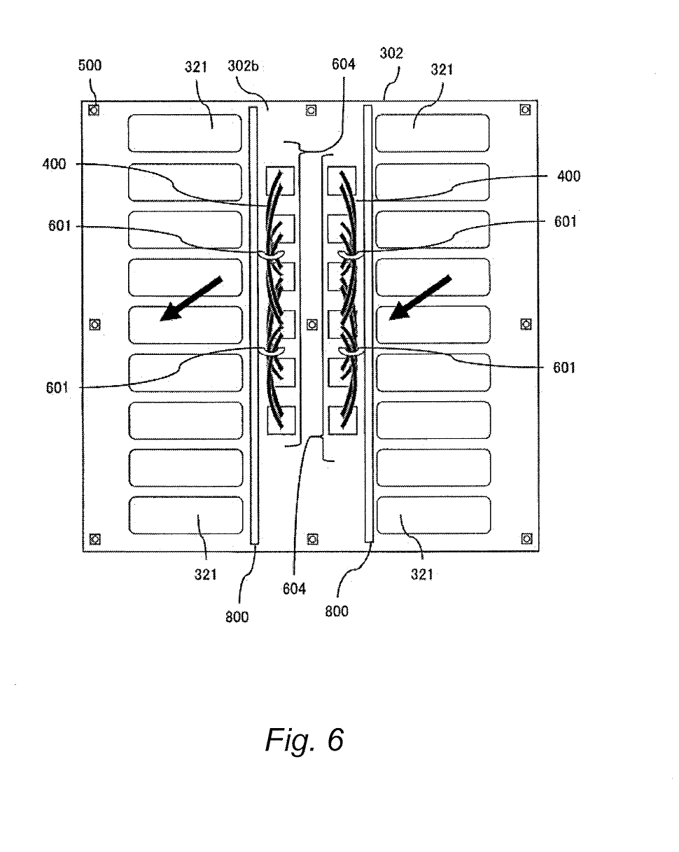

FIG. 5 is a front view for illustrating the backplane 302 according to the first embodiment, and FIG. 6 is a rear view for illustrating the backplane 302 according to the first embodiment. The thick arrows in FIG. 6 indicate the flow direction of the cooling air. The front surface 302a in the front of the backplane 302 includes nine threaded holes 500 for fixing the backplane 302 to the casing 301, a total of eighteen ventilation holes 321 in two rows, control signal connectors 501 for the basic control units 101, control signal connectors 502 for the packet processing units 102, control signal connectors 503 for the switch fabric units 103, the power supply unit connectors 322, and high-speed signal connectors 504. The lines coupling the connectors 320 (501 to 504) to each other are signal lines laid on the backplane 302. Those signal lines transmit signals corresponding to data to be transmitted at relatively low speed, such as a control signal. Signals corresponding to data to be transmitted at high speed are transmitted through the cables 400 routed on the rear surface 302b side in the rear of the backplane 302.

The control signal connectors 501 to 503 and the high-speed signal connectors 504 are arranged on the front surface 302a apart from each other across the ventilation holes 321. Specifically, as illustrated in FIG. 6, the rear surface 302b of the backplane 302 includes orthogonal type connectors 604 for the high-speed signal. The orthogonal type connectors 604 for the high-speed signal are coupled respectively to the high-speed signal connectors 504 on the front surface 302a immediately on the rear thereof. The orthogonal type connectors 604 for the high-speed signal are coupled electrically or optically to each other by the cables 400.

As viewed from the front surface 302a, the cables 400 are arranged so as not to overlap with the ventilation holes 321. In other words, on the rear surface 302b, the cables 400 are arranged to fall within a region excluding the ventilation holes 321. With this, the cooling air through the front of the casing 301 is less liable to impinge on the cables 400, and hence the flow of the cooling air is not hindered. Further, when the cooling air is less liable to impinge on the cables 400, the cables 400 are suppressed from being rocked. Thus, when electrical cables are used as the cables 400, contact failures and increase in electrical resistance are suppressed. As a result, malfunctions can be suppressed. Further, when optical cables are used as the cables 400, the loss due to optical axis misalignment or coupling angle fluctuation can be reduced.

Further, as an example of rocking suppressing means for the cables 400, fixing members 601 are used. The fixing members 601 fix the cables 400 to the rear surface 302b. The fixing members 601 may fix a plurality of the cables 400 in a bundle to the rear surface 302b. As another example of the rocking suppressing means for the cables 400, shields 800 may be used. As illustrated in FIG. 6, two shields 800 are arranged between the cables 400, which are coupled to the backplane 302, and the ventilation holes 321 to shield the cables 400 from the cooling air. It should be noted that both of the shields 800 and the fixing members 601 may be arranged, or at least one of the shields 800 and the fixing members 601 may be arranged.

With this, the cooling air does not impinge on the cables 400, and hence the cables 400 are suppressed from being rocked. Thus, when electrical cables are used as the cables 400, contact failures and increase in electrical resistance are suppressed. As a result, malfunctions can be suppressed. Further, when optical cables are used as the cables 400, the loss due to optical axis misalignment or coupling angle fluctuation can be reduced.

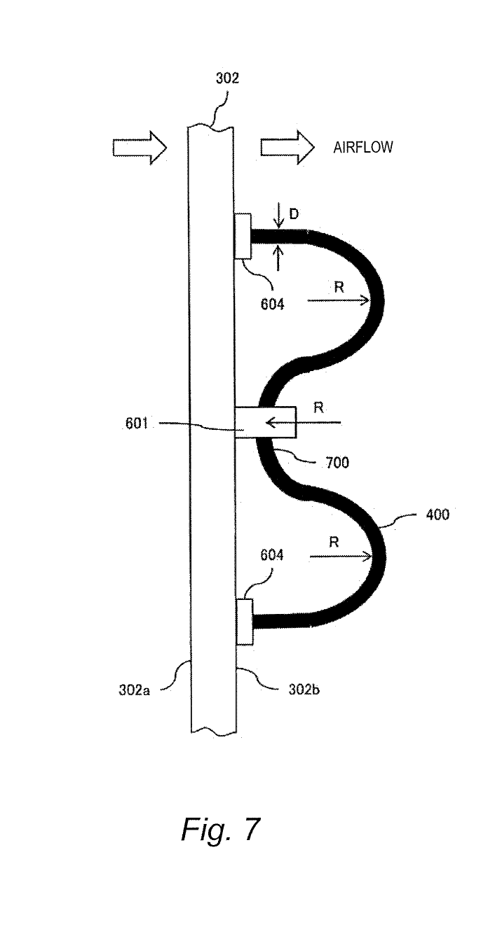

FIG. 7 is a side view for illustrating the fixing member 601 and the cable 400 fixed by the fixing member 601. The cable 400 for coupling the orthogonal type connectors 604 for the high-speed signal to each other is bent to the rear surface 302b side at a halfway portion 700 of the cable 400, and is fixed by the fixing member 601. A bending radius R of the cable 400 in this case is set to be equal to or larger than a predetermined bending radius. The predetermined bending radius is a minimum value of a bending radius to such an extent that communication quality of the cable 400 is not deteriorated. Specifically, it is preferred that, for example, the bending radius R be set to be five times to ten times as large as an outer diameter D of the cable 400 in a case of an electrical cable 400, or ten times to twenty times as large as the outer diameter D of the cable 400 in a case of an optical cable 400. With this, the bending radius of the cable 400 is maintained to be large, and hence the cable 400 is suppressed from being damaged or deteriorated in characteristics. In this way, while employing the cooling system of the front-and-rear air intake/exhaust type, cables can be arranged without being influenced by cooling air. As a result, signals can be transmitted at higher speed.

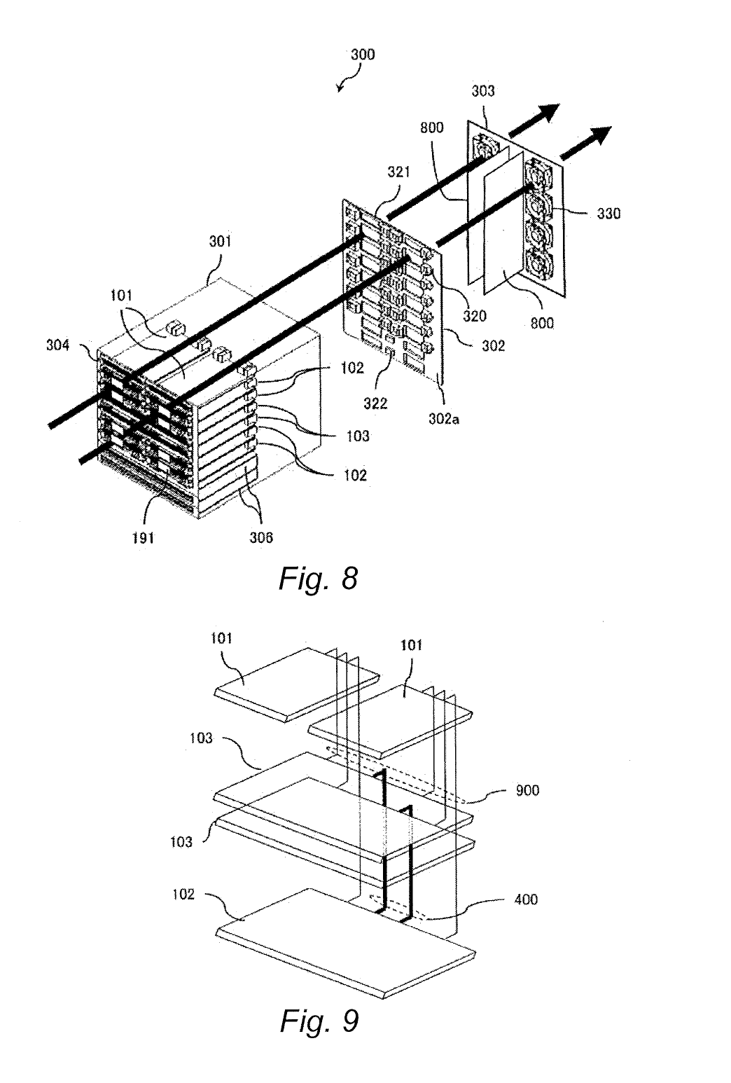

FIG. 8 is an exploded perspective view for illustrating the communication apparatus 300 in which still another example of the rocking suppressing means for the cables 400 is employed. In FIG. 8, the shields 800 are employed as the still another example of the rocking suppressing means. The shields 800 are arranged on a surface of the rear plate 303 to which the cooling fans 330 are mounted. The shields 800 are orthogonal to a plate surface of the rear plate 303.

With this, the cooling air does not impinge on the cables 400, and hence the cables 400 are suppressed from being rocked. Thus, when electrical cables are used as the cables 400, contact failures and increase in electrical resistance are suppressed. As a result, malfunctions can be suppressed. Further, when optical cables are used as the cables 400, the loss due to optical axis misalignment or coupling angle fluctuation can be reduced.

Next, description is made of a first modification of the first embodiment. In the first modification, description is made only of differences from the first embodiment, and description of features common to those in the first embodiment is omitted. In the example described in the first embodiment, the signals corresponding to the data to be transmitted at low speed, such as the control signal, are transmitted through the signal lines laid on the backplane 302. In the first modification, the signals corresponding to the data to be transmitted at low speed are also transmitted through the cables.

FIG. 9 is an explanatory view for illustrating a coupling relationship between the circuit boards 100 according to the first modification in a three-dimensional manner. In FIG. 9, for the sake of simplicity of description, only one of the packet processing units 102 is illustrated. Two basic control units 101 are mounted. The basic control units 101 are coupled to the packet processing unit 102 and the switch fabric units 103 by cables 900. In many cases, control signals from the basic control units 101 are transmitted at relatively low speed. In the communication apparatus 300, particularly high throughput is required between the packet processing unit 102 and the switch fabric units 103, and hence the SerDes is used for coupling therebetween by the cables 400.

On the front surface 302a in the front of the backplane 302 according to the first modification, unlike the first embodiment, signal lines are not laid. Other configurations are the same as those in FIG. 5.

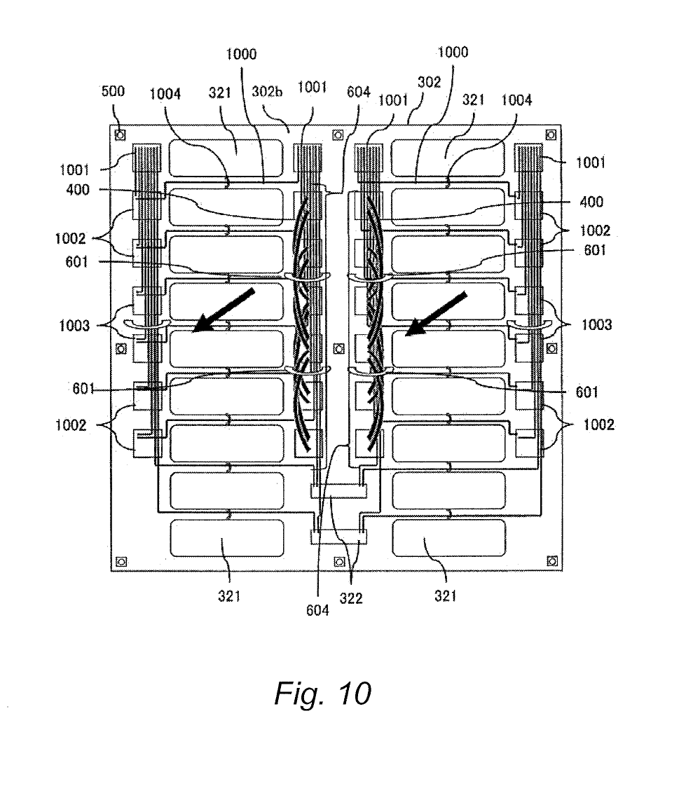

FIG. 10 is a rear view for illustrating the backplane 302 according to the first modification. In FIG. 10, on the rear surface 302b in the rear of the backplane 302, the orthogonal type connectors 604 for the high-speed signal and control signal rear connectors 1001 to 1003 are arranged. As in the first embodiment, the orthogonal type connectors 604 for the high-speed signal are coupled to each other by the cables 400 (hereinafter referred to as “first cables 400”).

The first modification is different from the first embodiment in that the control signal rear connectors 1001 to 1003 are arranged. The control signal rear connectors 1001 to 1003 are coupled to each other by cables 1000 for transmitting data at relatively low speed (hereinafter referred to as “second cables 1000”). As viewed from the front surface 302a, the second cables 1000 are also arranged so as not to overlap with the ventilation holes 321. In other words, on the rear surface 302b, the second cables 1000 are arranged to fall within regions excluding the ventilation holes 321.

With this, the cooling air through the front of the casing 301 is less liable to impinge on the second cables 1000, and hence the flow of the cooling air is not hindered. Further, when the cooling air is less liable to impinge on the second cables 1000, the second cables 1000 are suppressed from being rocked. Thus, when electrical cables are used as the second cables 1000, contact failures and increase in electrical resistance are suppressed. As a result, malfunctions can be suppressed. Further, when optical cables are used as the second cables 1000, the loss due to optical axis misalignment or coupling angle fluctuation can be reduced.

Further, as an example of rocking suppressing means for the second cables 1000, fixing members 1004 are used. The fixing members 1004 fix the second cables 1000 to the rear surface 302b. The fixing members 1004 may fix a plurality of the second cables 1000 in a bundle to the rear surface 302b.

In this way, in the first modification, data of the control signal is transmitted through the second cables 1000. With this configuration, on the backplane 302, only a power supply layer for the circuit boards 100 is arranged without a wiring pattern. Thus, manufacturing cost can be reduced, and hence the backplane 302 can be inexpensively provided.

Further, the cooling air through the front of the casing 301 is less liable to impinge on the cables 400, and hence the flow of the cooling air is not hindered. Further, when the cooling air is less liable to impinge on the cables 400, the cables 400 are suppressed from being rocked. Thus, when electrical cables are used as the cables 400, contact failures and increase in electrical resistance are suppressed. As a result, malfunctions can be suppressed. Further, when optical cables are used as the cables 400, the loss due to optical axis misalignment or coupling angle fluctuation can be reduced.

Next, description is made of a second modification of the first embodiment. In the second modification, description is made only of differences from the first embodiment, and description of features common to those in the first embodiment is omitted. In the first embodiment, the switch fabric units 103 are inserted into the front surface 302a side of the backplane 302. Meanwhile, in the second modification, the switch fabric units 103 are arranged on the rear surface 302b side of the backplane 302. With this, the space in the casing 301 can be effectively used, and a height of the stacked circuit boards 100 is reduced by heights of the removed switch fabric units 103. Thus, a height of the casing 301 can be reduced. Therefore, the communication apparatus 300 can be downsized.

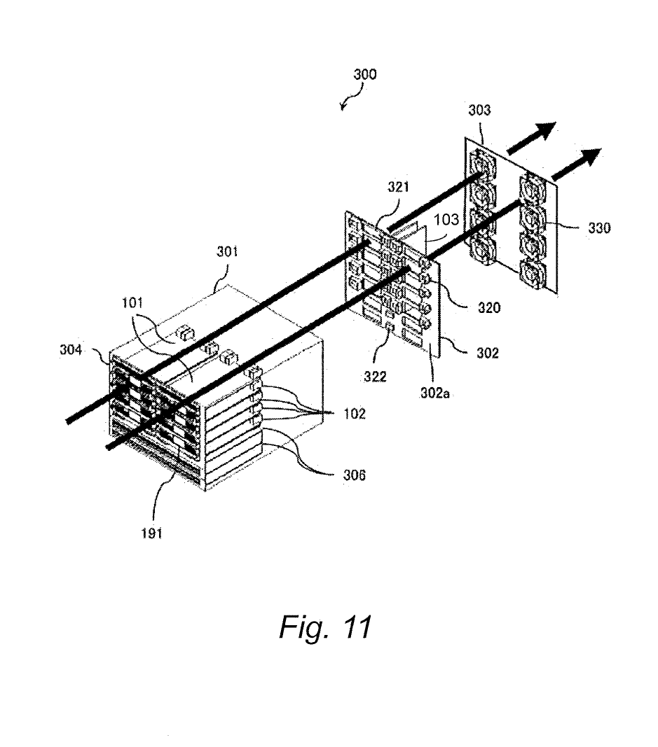

FIG. 11 is an exploded perspective view for illustrating the communication apparatus 300 according to the second modification. The communication apparatus 300 includes the casing 301, the backplane 302, and the rear plate 303. The plurality of circuit boards 100 are arranged in the casing 301. The plurality of circuit boards 100 are inserted in a horizontal state from the front of the casing 301. As an example, in the casing 301, the basic control units 101 are inserted into the first row from the top, the packet processing units 102 are inserted into the second row to the fifth row, and the power supply units 306 are inserted into the sixth row and the seventh row (lowermost row).

The switch fabric units 103 are inserted into the rear surface 302b side of the backplane 302. The switch fabric units 103 are inserted orthogonally to the other circuit boards 100. The switch fabric units 103 are inserted to positions at which the ventilation holes 321 are not closed. The basic control units 101 and the packet processing units 102 are coupled to the switch fabric units 103 by connectors through intermediation of the backplane 302.

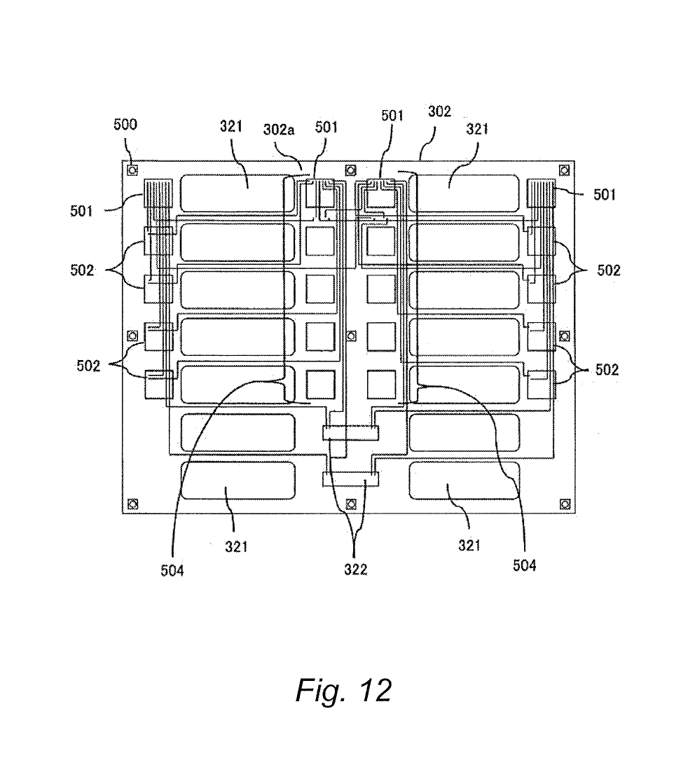

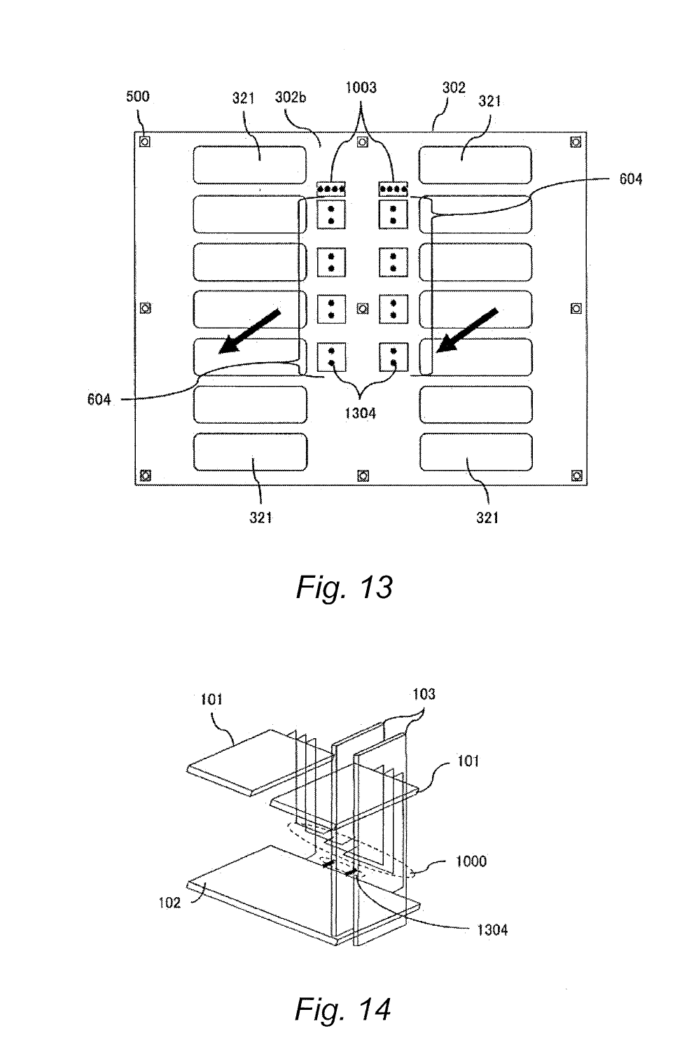

FIG. 12 is a front view for illustrating the backplane 302 according to the second modification, and FIG. 13 is a rear view for illustrating the backplane 302 according to the second modification. On the front surface 302a in the front of the backplane 302 according to the second modification, the control signal connectors 503 for the switch fabric units 103 are omitted.

Meanwhile, the orthogonal type connectors 604 for the high-speed signal are used for coupling of signals for performing high-speed data transmission. In this case, without intermediation of the signal lines or the cables on the circuit boards, the circuit boards on the front surface 302a side (packet processing units 102) and the circuit boards on the rear surface 302b side (switch fabric units 103) are coupled directly to each other through through-holes 1304 of the backplane 302. Further, the switch fabric units 103 are coupled by the control signal rear connectors 1003 from the rear surface 302b side of the backplane 302. Other configurations are the same as those in FIG. 5 in the first embodiment.

In this way, according to the configuration of the second modification, while employing the cooling system of the front-and-rear air intake/exhaust type, the circuit boards 101, 102, and 306 on the front surface 302a side and the switch fabric units 103 on the rear surface 302b side, between which data is transmitted at high speed, are coupled to each other through the through-holes 1304 of the backplane 302. With this, signals can be transmitted at higher speed. Further, unlike the first embodiment, the cables 400 are omitted. Thus, the cables 400 are not rocked by the cooling air. Therefore, the contact failures, the increase in electrical resistance, and the loss due to optical axis misalignment or coupling angle fluctuation do not occur.

Next, description is made of a third modification of the first embodiment. In the third modification, description is made only of differences from the second modification, and description of features common to those in the second modification is omitted. The configuration of the third modification is obtained through application of the first modification to the second modification. In the second modification, the signals corresponding to the data to be transmitted at low speed, such as the control signal, are transmitted through the signal lines laid on the backplane 302. In the third modification, the signals corresponding to the data to be transmitted at low speed are also transmitted through the second cables 1000.

FIG. 14 is an explanatory view for illustrating a coupling relationship between the circuit boards 100 according to the third modification in a three-dimensional manner. In FIG. 14, for the sake of simplicity of description, only one of the packet processing units 102 is illustrated. Two basic control units 101 are mounted. The basic control units 101 are coupled to the packet processing unit 102 and the switch fabric units 103 by the second cables 1000. In many cases, the control signals from the basic control units 101 are transmitted at relatively low speed. In the communication apparatus 300, particularly high throughput is required between the packet processing unit 102 and the switch fabric units 103, and hence those units are coupled to each other through the through-holes 1304 of the backplane 302.

In comparison with the second modification, the packet processing unit 102 and the switch fabric units 103 are arranged closer to each other. Thus, in the communication apparatus 300 according to the third modification, a cable length of the second cables 1000 can be reduced. In this way, unlike the second modification, the switch fabric units 103 to occupy the two rows are not inserted from the front of the casing 301. Thus, the height of the casing 301 can be reduced, and hence the communication apparatus 300 can be downsized.

Further, on the front surface 302a in the front of the backplane 302 according to the third modification, unlike the second modification and the first embodiment, signal lines are not laid.

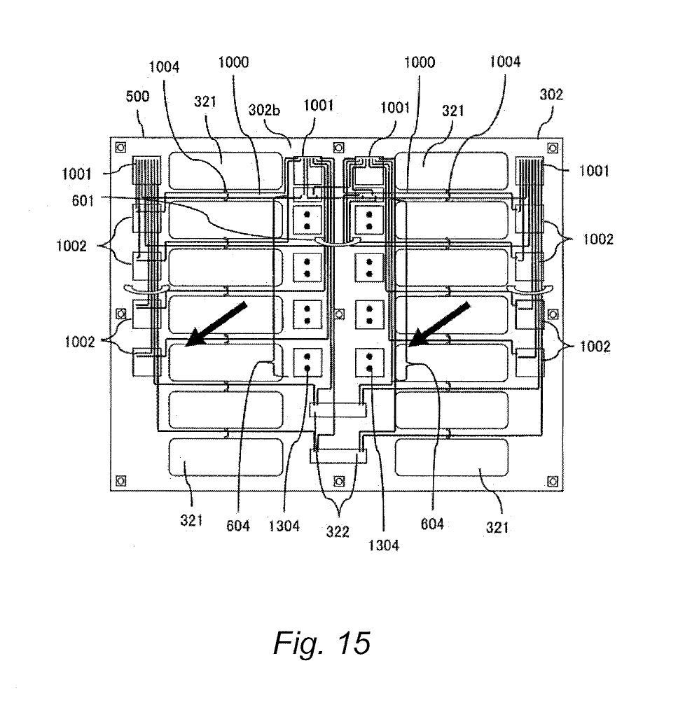

FIG. 15 is a rear view for illustrating the backplane 302 according to the third modification. In FIG. 15, on the rear surface 302b in the rear of the backplane 302, the orthogonal type connectors 604 for the high-speed signal and the control signal rear connectors 1001 and 1002 are arranged. As in the second modification, with the orthogonal type connectors 604 for the high-speed signal, the circuit boards 100 on the front surface 302a side and the circuit boards 100 on the rear surface 302b side are coupled directly to each other through the through-holes 1304 of the backplane 302.

The third modification is different from the second modification in that the control signal rear connectors 1001 and 1002 are arranged. The control signal rear connectors 1001 and 1002 are coupled to each other by the cables 1000 for transmitting data at relatively low speed. As viewed from the front surface 302a, those cables 1000 are arranged so as not to overlap with the ventilation holes 321. In other words, on the rear surface 302b, the cables 1000 are arranged to fall within the regions excluding the ventilation holes 321.

With this, the cooling air through the front of the casing 301 is less liable to impinge on the cables 1000, and hence the flow of the cooling air is not hindered. Further, when the cooling air is less liable to impinge on the cables 1000, the cables 1000 are suppressed from being rocked. Thus, when electrical cables are used as the cables 1000, contact failures and increase in electrical resistance are suppressed. As a result, malfunctions can be suppressed. Further, when optical cables are used as the cables 1000, the loss due to optical axis misalignment or coupling angle fluctuation can be reduced.

Further, as an example of the rocking suppressing means for the cables 1000, the fixing members 1004 are used. The fixing members 1004 fix the cables 1000 to the rear surface 302b. The fixing members 1004 may fix a plurality of the cables 1000 in a bundle to the rear surface 302b.

In this way, in the third modification, data of the control signal is transmitted through the cables 1000. With this configuration, on the backplane 302, only a power supply layer for the circuit board units is arranged without a wiring pattern. Thus, manufacturing cost can be reduced, and hence the backplane 302 can be inexpensively provided.

Further, unlike the second modification, the cables 400 are omitted. Thus, the cables 400 are not rocked by the cooling air. Therefore, the contact failures, the increase in electrical resistance, and the loss due to optical axis misalignment or coupling angle fluctuation do not occur.

Next, description is made of a fourth modification of the first embodiment. In the fourth modification, description is made only of differences from the second modification, and description of features common to those in the second modification is omitted. The configuration of the fourth modification is obtained by changing the arrangement of the power supply units 306 from that in the configuration of the second modification.

In the second modification, the power supply units 306 are inserted into the front surface 302a side of the backplane 302. Meanwhile, in the fourth modification, the power supply units 306 together with the switch fabric units 103 are arranged on the rear surface 302b side of the backplane 302. With this, the space in the casing 301 can be effectively used, and the height of the stacked circuit boards 100 is reduced by heights of the removed power supply units 306. Thus, the height of the casing 301 can be reduced. Therefore, the communication apparatus 300 can be downsized.

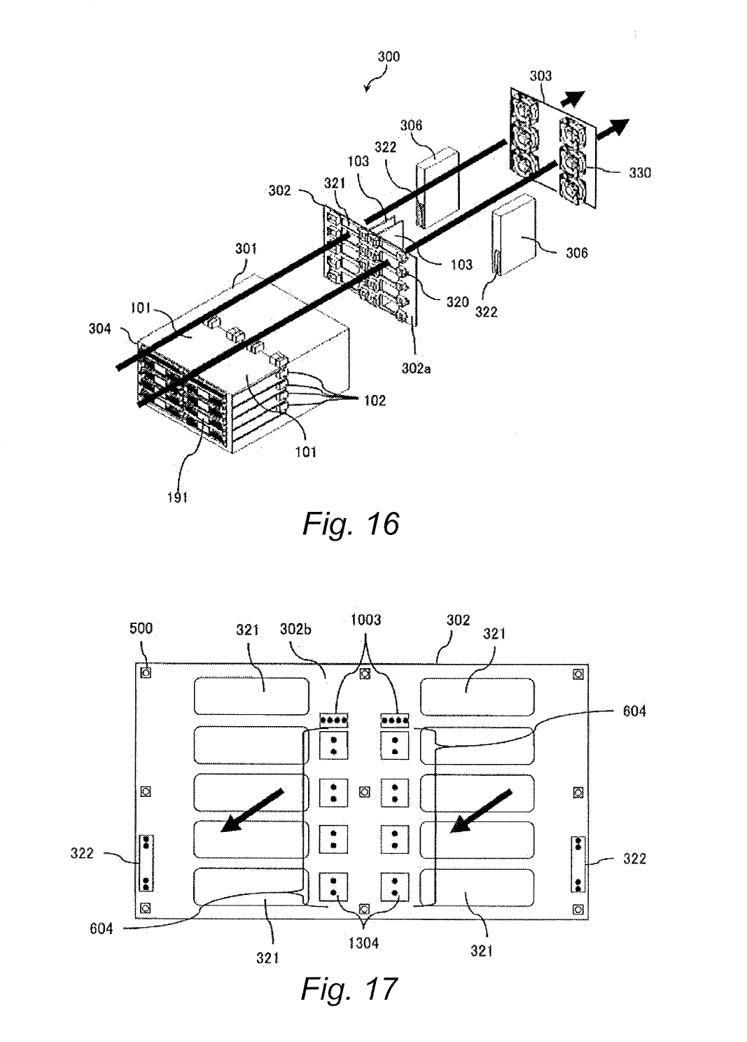

FIG. 16 is an exploded perspective view for illustrating the communication apparatus 300 according to the fourth modification. The communication apparatus 300 includes the casing 301, the backplane 302, and the rear plate 303. The plurality of circuit boards 100 are arranged in the casing 301. The plurality of circuit boards 100 are inserted in a horizontal state from the front of the casing 301. As an example, in the casing 301, the basic control units 101 are inserted into the first row from the top, and the packet processing units 102 are inserted into the second row to the fifth row (lowermost row).

The switch fabric units 103 are arranged at the same positions as those in FIG. 11. The power supply units 306 are inserted into the rear surface 302b side of the backplane 302. The power supply units 306 are inserted orthogonally to the other circuit boards 100 on the front surface 302a side. The power supply units 306 are inserted to positions at which the ventilation holes 321 are not closed. The power supply units 306 are coupled to the backplane 302 by the power supply unit connectors 322 from the rear surface 302b side. Other configurations of the power supply units 306 are the same as those in the embodiment described above.

On the front surface 302a in the front of the backplane 302 according to the fourth modification, the high-speed signal connectors 504 are arranged at the positions of the power supply unit connectors 322 unlike FIG. 12. Further, unlike FIG. 12, the control signal connectors 502 for the packet processing units 102 are arranged on an opposite side of the side on which the high-speed signal connectors 504 are arranged with respect to the ventilation holes. Other configurations are the same as those in FIG. 12.

The fourth modification is different from the second modification in that the power supply units 306 are arranged on the rear surface 302b side of the backplane 302. Thus, the height of the casing 301 is reduced, and the ventilation holes 321 for the power supply units 306 are unnecessary. Therefore, a height of the backplane 302 is reduced. With this, the communication apparatus 300 is downsized.

FIG. 17 is a rear view for illustrating the backplane 302 according to the fourth modification. Further, FIG. 17 in the fourth modification is different from FIG. 13 in the second modification in that the power supply units 306 are arranged on the rear surface 302b side of the backplane 302, and hence the power supply unit connectors 322 are mounted to the rear surface 302b of the backplane 302. With this, power is supplied from the power supply units 306 to the circuit boards 100 via the backplane 302. Further, on the rear surface 302b of the backplane 302, the power supply units 306 are arranged at both horizontal edges so as not to overlap with the ventilation holes 321. With this, the power supply units 306 do not close the ventilation holes 321, and hence reduction in cooling efficiency can be prevented.

In this way, according to the configuration of the fourth modification, while employing the cooling system of the front-and-rear air intake/exhaust type, the circuit boards on the front surface 302a side and the circuit boards on the rear surface 302b side, between which data is transmitted at high speed, are coupled directly to each other. With this, signals can be transmitted at higher speed. Further, the power supply units 306 are arranged on the rear surface 302b side of the backplane 302, and hence a height of the stacked circuit boards can be reduced. Therefore, the communication apparatus 300 can be downsized.

Next, description is made of a fifth modification of the first embodiment. In the fifth modification, description is made only of differences from the fourth modification, and description of features common to those in the fourth modification is omitted. The configuration of the fifth modification is obtained through application of the first modification to the fourth modification. In the fourth modification, the signals corresponding to the data to be transmitted at low speed, such as the control signal, are transmitted through the signal lines laid on the backplane 302. In the fifth modification, the signals corresponding to the data to be transmitted at low speed are also transmitted through the cables. The signal lines are not laid on the front surface 302a in the front of the backplane 302 according to the fifth modification. Other configurations of the front surface 302a are the same as those in the fourth modification.

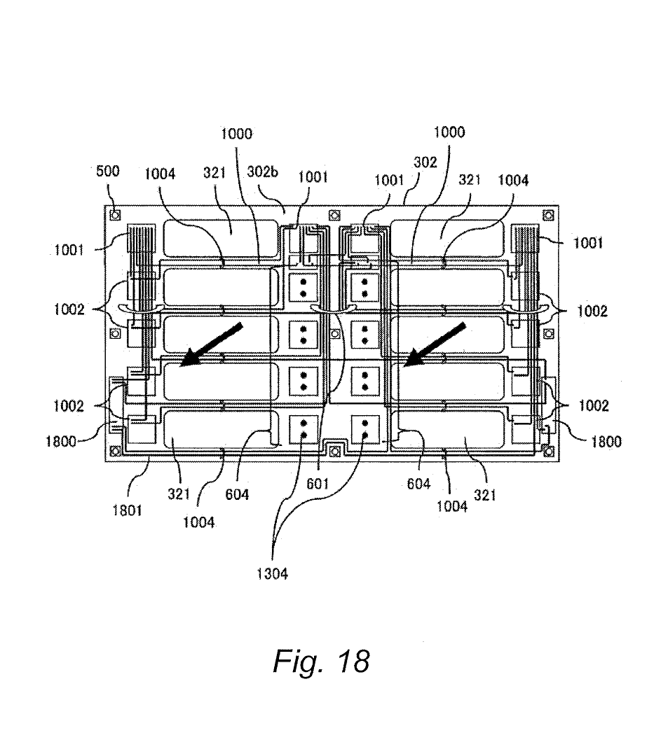

FIG. 18 is a rear view for illustrating the backplane 302 according to the fifth modification. In FIG. 18, on the rear surface 302b in the rear of the backplane 302, the orthogonal type connectors 604 for the high-speed signal, the control signal rear connectors 1002, and power supply rear connectors 1800 are arranged. As in the fourth modification, with the orthogonal type connectors 604 for the high-speed signal, the circuit boards 100 on the front surface 302a side and the circuit boards 100 on the rear surface 302b side are coupled directly to each other through the through-holes 1304 of the backplane 302.

The fifth modification is different from the fourth modification in that the control signal rear connectors 1002 are arranged. The control signal rear connectors 1002 are coupled to each other by the cables 1000 for transmitting data at relatively low speed. As viewed from the front surface 302a, the cables 1000 are also arranged so as not to overlap with the ventilation holes 321. In other words, on the rear surface 302b, the cables 1000 are arranged to fall within the regions excluding the ventilation holes 321.

The fifth modification is also different from the fourth modification in that the power supply rear connectors 1800 are arranged. The power supply rear connectors 1800 and the control signal rear connectors 1001 are coupled to each other by power supply control cables 1801. As viewed from the front surface 302a, the cables 1801 are also arranged so as not to overlap with the ventilation holes 321. In other words, on the rear surface 302b, the cables 1801 are arranged to fall within the regions excluding the ventilation holes 321.

With this, the cooling air through the front of the casing 301 is less liable to impinge on the cables 1000 and 1801, and hence the flow of the cooling air is not hindered. Further, when the cooling air is less liable to impinge on the cables 1000 and 1801, the cables 1000 and 1801 are suppressed from being rocked. Thus, when electrical coupling cables are used as the cables 1000 and 1801, contact failures and increase in electrical resistance are suppressed. As a result, malfunctions can be suppressed. Further, when optical coupling cables are used as the cables 1000 and 1801, the loss due to optical axis misalignment or coupling angle fluctuation can be reduced.

Further, as an example of the rocking suppressing means for the cables 1000 and 1801, the fixing members 1004 are used. The fixing members 1004 fix the cables 1000 and 1801 to the rear surface 302b. The fixing members 1004 may fix a plurality of the cables 1000 and 1801 in a bundle to the rear surface 302b.

In this way, in the fifth modification, data of the control signal is transmitted through the cables 1000, and power supply control is performed through the cables 1801. With this configuration, on the backplane 302, only a power supply layer for the circuit boards 100 is arranged without a wiring pattern. Thus, manufacturing cost can be reduced, and hence the backplane 302 can be inexpensively provided.

As described above, the communication apparatus according to this embodiment is capable of reducing risks when cables are rocked due to impingement of cooling air, specifically, malfunctions due to contact failures or increase in electrical resistance when electrical cables are used for coupling, and influence of increase in loss due to optical axis misalignment or coupling angle fluctuation when optical cables are used for coupling. Further, the bending radius of the cables can be maintained to be large so that the cables are suppressed from being damaged or deteriorated in characteristics. With this, signals can be transmitted at higher speed.

Still further, in the communication apparatus, a wiring layer including signal lines laid on the backplane is omitted so that only a power supply layer for circuit boards is arranged on the backplane. With this, manufacturing cost of the backplane can be reduced.

Yet further, in the system employed in the embodiment described above, cooling air is taken in through the mesh-like ventilation holes 305 in the front of the communication apparatus 300, flows through the ventilation holes 321 of the backplane 302, and then is exhausted toward the rear of the communication apparatus. Alternatively, the cooling fans 330 may be replaced with push-type cooling fans so that cooling air is taken in from the rear of the communication apparatus 300 and exhausted to the front of the communication apparatus 300.

Yet further, in the embodiment described above, the power supply units 306 are inserted to be horizontal from the front of the communication apparatus 300. Alternatively, the power supply units 306 may be inserted to be horizontal from the rear of the communication apparatus 300. Yet further, in the fourth and fifth modifications, the power supply units 306 are inserted to be vertical from the rear of the communication apparatus 300. Alternatively, the power supply units 306 may be inserted to be vertical from the front of the communication apparatus 300.

Yet further, the cooling fans 330 are mounted to the communication apparatus 300 in the example described above. However, the cooling fans 330 need not necessarily be mounted to the communication apparatus 300, and may be arranged on an outside of the communication apparatus 300 at positions behind the rear plate 303. With this, the communication apparatus 300 can be downsized.

Further, a plurality of the communication apparatus 300 described above may be arrayed. In this case, the communication apparatus 300 are arrayed in a direction orthogonal to the ventilation direction of the cooling air. For example, the communication apparatus 300 are arrayed vertically or horizontally. With this, all the communication apparatus 300 can be cooled without taking in cooling air that is exhausted from the other communication apparatus 300.

Further, the communication apparatus is employed in the embodiment described above. However, the embodiment is applicable also to information processing apparatus such as a server without departing from the gist of this invention.

This invention has been described in detail so far with reference to the accompanying drawings, but this invention is not limited to those specific configurations described above, and includes various changes and equivalent components within the gist of the scope of claims appended.

1. A communication apparatus, including:
a plurality of circuit boards;
a casing to which the plurality of circuits boards are inserted, the casing being configured such that air is controlled to flow in a ventilation direction as one of:
a direction in which air taken in through a first surface of the casing is controlled to flow between the plurality of circuits boards and exhausted to an outside of the communication apparatus through a second surface of the casing opposite to the first surface, and in which the plurality of circuits boards are one of inserted and removed; and
a direction in which air taken in through the second surface is controlled to flow between the plurality of circuit boards and exhausted to the outside through the first surface, and in which the plurality of circuits boards are one of inserted and removed;
a coupling plate being arranged between the first surface and the second surface in the casing, and having ventilation holes for communicating a first space on the first surface side and a second space on the second surface side to each other, the coupling plate having the plurality of circuit boards coupled to a third surface of the coupling plate, which faces the first surface; and
cables routed in a third space defined in the second space excluding fourth spaces in which the ventilation holes are projected on the second surface in the ventilation direction, the cables coupling the plurality of circuit boards to each other on a fourth surface which faces the second surface so that the plurality of circuit boards are communicable to each other.

2. The communication apparatus according to claim 1, further including rocking suppressing means configured to suppress the cables from being rocked by the air flowing through the fourth spaces.

3. The communication apparatus according to claim 2, wherein the rocking suppressing means includes a fixing member configured to fix a halfway portion of each of the cables to the fourth surface.

4. The communication apparatus according to claim 3, wherein the fixing member fixes the halfway portion under a state in which the each of the cables is bent with a bending radius equal to or larger than a predetermined bending radius.

5. The communication apparatus according to claim 2, wherein the rocking suppressing means includes a plate member configured to partition the fourth spaces from the second space.

6. The communication apparatus according to claim 1, wherein the coupling plate includes a wiring layer configured to couple the plurality of circuit boards to each other so that a first signal to be transmitted at a transmission speed lower than a transmission speed of a second signal to be transmitted through the each of the cables is communicable between the plurality of circuit boards.

7. The communication apparatus according to claim 1, further including other cables routed in the third space on the fourth surface that faces the second surface, configured to couple the plurality of circuit boards to each other so that the first signal to be transmitted at the transmission speed lower than the transmission speed of the second signal to be transmitted through the each of the cables is communicable between the plurality of circuit boards.

8. A communication apparatus, including:
a plurality of circuit boards including:
first circuit boards configured to process packets;
second circuit boards configured to control data to be transmitted between the first circuit boards; and
third circuit boards for supplying power to the first circuit boards and the second circuit boards;
a casing to which the plurality of circuits boards are inserted, the casing being configured such that air is controlled to flow in a ventilation direction as one of:
a direction in which air taken in through a first surface of the casing is controlled to flow between the plurality of circuits boards and exhausted to an outside of the communication apparatus through a second surface of the casing opposite to the first surface, and in which the plurality of circuits boards are one of inserted and removed; and
a direction in which air taken in through the second surface is controlled to flow between the plurality of circuit boards and exhausted to the outside through the first surface, and in which the plurality of circuits boards are one of inserted and removed; and
a coupling plate being arranged between the first surface and the second surface in the casing, and having ventilation holes for communicating a first space on the first surface side and a second space on the second surface side to each other, the coupling plate having the first circuit boards and the third circuit boards coupled to a third surface of the coupling plate, which faces the first surface, and the second circuit boards coupled to a fourth surface of the coupling plate, which faces the second surface, so that the data is transmittable between the first circuit boards via the second circuit boards, and that the power is suppliable from the third circuit boards to the first circuit boards and the second circuit boards.

9. The communication apparatus according to claim 8,
wherein the plurality of circuit boards include fourth circuit boards for controlling the first circuit boards, the second circuit boards, and the third circuit boards, and
wherein the fourth circuit boards are coupled to the third surface of the coupling plate so that a control signal is transmittable from the fourth circuit boards to the first circuit boards, the second circuit boards, and the third circuit boards.

10. The communication apparatus according to claim 8, wherein the coupling plate has through-holes for allowing the first circuit boards and the second circuit boards to be coupled to each other so that the data is transmittable between the first circuit boards and the second circuit boards.
